(19) United States
(12) Patent Application Publication
(10) Pub. No.: US 2016/0125341 A1
(43) Pub. Date: May 5, 2016

(54) FLOOR PLAN BASED WORKFLOW MAPPING

(71) Applicant: NewField Information Technology Ltd., Twickenham (GB)

(72) Inventors: James Jeffrey Duckenfield, London (GB); Baber Shehzad Khalil, Hemel Hempstead (GB); Robert Francis John Needham Viscount Newry and Morne, London (GB); Simon John Gardner, London (GB); Ian David Kerr, London (GB)

(21) Appl. No.: 14/528,553

(22) Filed: Oct. 30, 2014

(51) Int. Cl. G06Q 10/06; G06Q 10/10

(52) U.S. Cl. CPC G06Q 10/06316; G06Q 10/105

(57) ABSTRACT

A system for presenting graphic depictions of a workflow in a workplace gathers information to help it automatically identify the workflow. The system presents surveys to human resources and receives responses to develop various segments of the workflow. The system resolves any gaps by using the received responses to identify additional human resources who should receive surveys. It then presents surveys to the additional human resources, receives additional responses, and uses the additional responses to complete the workflow.

### BACKGROUND

In facilities that engage in manufacturing or other business processes, it is common to create a graphical map of the process to help visualize a workflow associated with the process. Workflow mapping is commonly done in one of two ways. In one method, a workflow is represented as a flow chart with “swim lanes” to illustrate team handoffs. FIG. 1 illustrates an example of such a flowchart.

In another embodiment, workflow paths may be mapped to a floor of a production facility or other workplace in a format that is commonly known as a “spaghetti diagram.” FIG. 2 illustrates an example of such a diagram. In FIG. 2, spaghetti diagram 200 includes a graphical representation of the production facility 210 along with graphical representation of various production resources, exemplified by 220a-c, within the facility. The diagram also includes a graph of the routes taken by any number of workflows 230 within the facility. A method of automatically creating a spaghetti diagram such as that shown in FIG. 2 is described in U.S. Patent Application Pub. No. 2013/0346168, filed by Rai, titled “Creation of Production Process Workflow Diagrams,” the disclosure of which is fully incorporated herein by reference.

### SUMMARY

In an embodiment, a system that includes a processor and a non-transitory, computer-readable medium gathers information for use in an automatic generation of a workflow, of a graphic representation of a workflow, or both. The system presents a group of human resources in a workplace environment with a survey. The survey solicits a data element set that includes at least the following data elements: a workplace resource, a parameter that describes an output, an input description, and an immediate next destination. The system receives responses from the human resources in response to the survey. Each response includes data elements that correspond to the solicited data element set. The system uses the data elements received in the responses to automatically develop a portion of a workflow for a job that is produced in the workplace environment. The system then uses the workflow and the received data elements to identify an additional human resource to whom the survey should be presented. In some embodiments, the system may then present the survey to the additional human resource, receive additional data elements for the data element set from the additional human resource, use the received additional data elements to automatically complete the workflow for the job, and present the completed workflow to a user.

Optionally, when presenting the workflow to the user, the system may cause a display device to output a graphic representation of the workplace environment along with a graphic depiction of the workflow as a route that connects workplace resources in the workplace environment.

Optionally, for each connected workplace resource, the system may display a process icon that causes the display device to display one or more parameters of a step of the workflow that occurs at the workplace resource. When by user input a user activates the displayed process icon, then in response the system may automatically display a flowchart representation of a portion of the workflow that includes the workplace resource that is associated with the process icon.

Optionally, the process icon corresponds to a remote workplace resource that is present at a portion of the workplace environment that is not presently displayed on the display device. If so, then when a user activates the process icon, the system may cause the display device to display the portion of the workplace environment at which the remote workplace resource is located.

Optionally, when automatically developing a portion of a workflow for a job that is produced in the workplace environment, the system may analyze the data elements received in the response to select a subgroup of the responses that correspond to a single job. Then, for each first response in the subgroup, the system may analyze the first response to identify the workplace resource that is part of the first response, analyze the first response's input description and immediate next destination to identify a second response that corresponds to an adjacent workplace resource, and link the workplace resource of the first response and the adjacent workplace resources as a segment of the workflow.

Optionally, using the workflow and the received data elements to identify an additional human resource to whom the survey should be presented may include identifying a gap in the workflow. The gap may include a starting node or an ending node that corresponds to a particular human resource in the workplace environment. The system may analyze the survey response for the particular human resource to identify the input description, immediate next destination or both that are contained in the survey response for the particular human resource, select an unsurveyed human resource who is associated with the input description or immediate next destination that are contained in the survey response for the particular human resource; and identify the selected unsurveyed human resource as the additional human resource to whom the survey should be presented.

### BRIEF DESCRIPTION OF THE DRAWINGS

FIG. 1 is an example of a prior art method of generating a workflow diagram.

FIG. 2 is an example of an alternate prior art method of generating a workflow diagram.

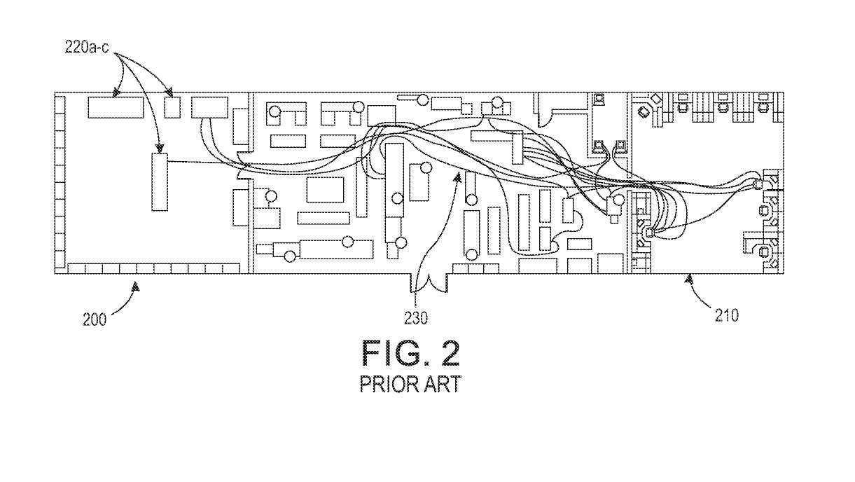

FIG. 3 illustrates an example of a graphic depiction of an area of a workplace environment and a workflow that is implemented in the area.

FIG. 4 illustrates an example of a graphic depiction of a first workplace area where certain steps of a workflow occurs, with a link to a second production facility area where an additional step of the workflow occurs.

FIG. 5 is a flowchart illustrating a procedure of soliciting user information to develop a depiction of a workflow.

FIG. 6 illustrates an example of a user interface by which the system may present a survey to a user.

FIG. 7 is a block diagram showing elements of computing systems that may be used to implement various embodiments described in this document.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

In this document, a “computing device” or “computer” refers to a device that includes a processor and non-transitory, computer-readable memory. The memory may contain programming instructions that, when executed by the processor, cause the computing device to perform one or more operations according to the programming instructions. As used in this description, a computing device may be a single device, or any number of devices having one or more processors that communicate with each other and share data and/or instructions.

An “inventory item” refers to material used in a workplace environment to produce one or more units of output. An inventory item may be a consumable or other replenishable or replaceable material. For instance, in a print production environment, an inventory item may include, without limitation, toner, paper or other media.

A “job” refers to a logical unit of work that is to be completed in a workplace environment. A job will yield an “output,” which is an item of work produced in a workplace environment. For example, in a workplace that includes a print production environment, a job may include one or more print jobs from one or more clients. Such a job may be referred to as a “print job.” Examples of print job outputs include bank statements, mailings, or other documents.

A “workplace device” device refers to a device used to process at least a portion of a job. Examples of workplace devices in a print shop may include, without limitation, printers, inserters, binders, punchers, collators, multi-function devices or other similar equipment and/or the like. Workplace devices in other environments may include a computer terminal in an office, a file storage facility, or a manufacturing device. A “human resource” is a human worker who performs one or more tasks of a job. A “workplace resource” or “resource” is a general term that is used to refer to a production device or human resource.

A “workplace” or “workplace environment” refers to a facility or group of facilities containing workplace resources that collectively are used to implement a workflow. Example workplace environments may include, without limitation, an actual or virtual office, a print production environment, a vehicle production environment, a computing device manufacturing environment, and/or other manufacturing or production environments.

As used in this document, a “workflow” refers to a collection of steps that collectively make up a job. A description of a workflow may include parameters for each step such as the resource or resources that implement the step, inventory items that are used in each step, a location within a workplace environment where the step occurs, and/or other parameters. Example workflows include manufacturing workflows, document creation workflows, creative copy production workflows, report generation workflows and the like.

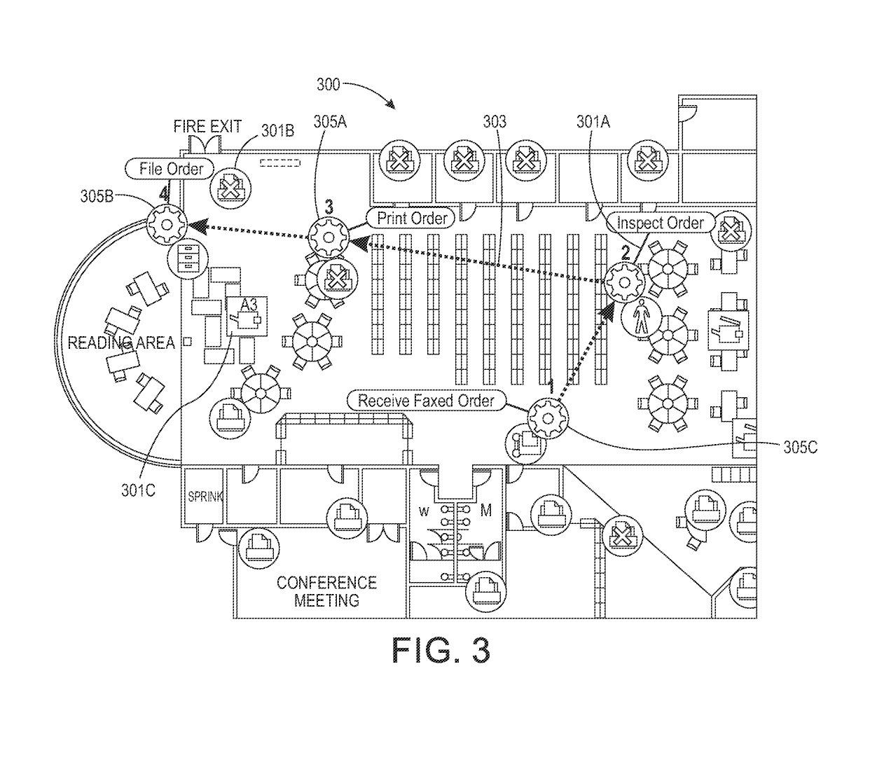

In the embodiments of this document, a system gathers information to be used in the automatic generation of a graphic representation of a workflow. The system also may present the graphic representation of the workflow in its workplace environment to one or more users of the system. An example of such a graphic representation is illustrated in FIG. 3. FIG. 3 shows how a display device may output a representation of a portion of the workplace environment 300, in this example a map of an area of a print production facility. The representation displays multiple resources such as 301a . . . 301c and their locations in the production facility. The representation also displays a representation of the workflow as a route 303 that a job follows as it moves from resource to resource at the facility. The representation also includes one or more process icons such as 305a . . . 305c that represent nodes at which a step in the workflow may occur.

As shown, some or all of the process icons may display one or more parameters of a step of the workflow that occurs at the icon's associated resource. For example, the parameters may include an action in the workflow that occurs at the resource, an inventory item used at the resource, an identification of the resource, a processing time that is associated with the step, or other parameters. Some of the parameters may be displayed automatically, and/or some parameters may be displayed in response to user activation of the process icon. User activation may occur if the user clicks on, double-clicks on, touches, hovers over, voice-activates, or otherwise selects the icon.

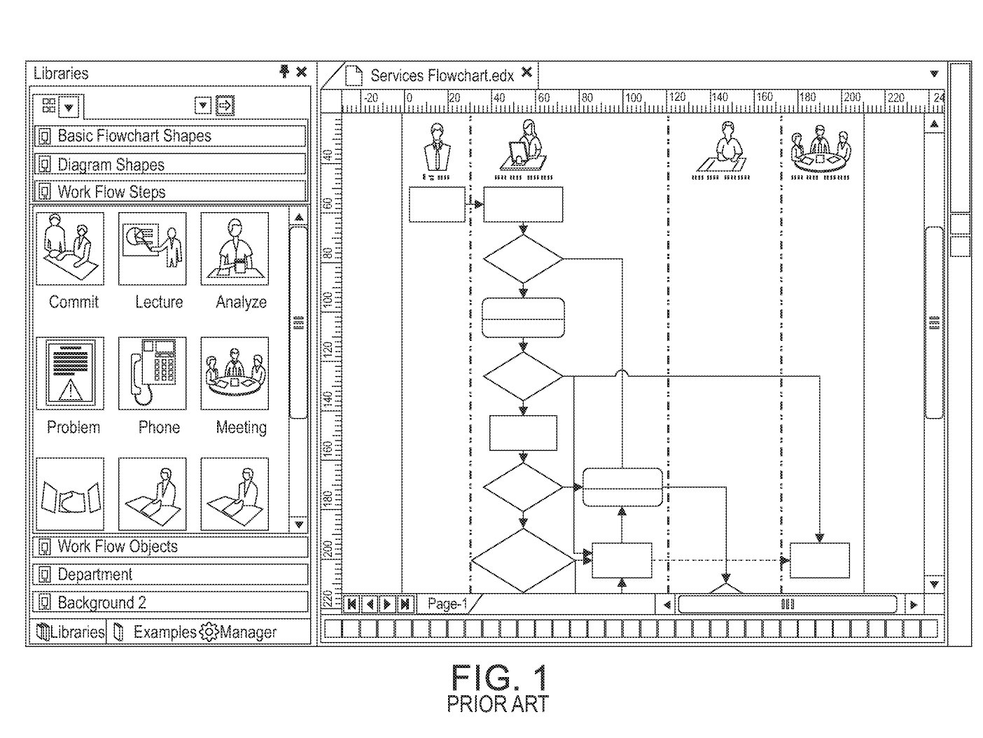

Optionally, different activation actions may yield different levels of detail or different types of parameters. Alternatively, different activation actions may yield a result other than a display of parameters. For example, hovering over an icon may cause the system to display a process parameter, while clicking on an icon may cause the system to display a different representation of the workflow. In some embodiments, the different representation may be a flowchart representation of a portion of the workflow that includes the resource that is associated with the activated process icon. An example of such a representation is illustrated in FIG. 1.

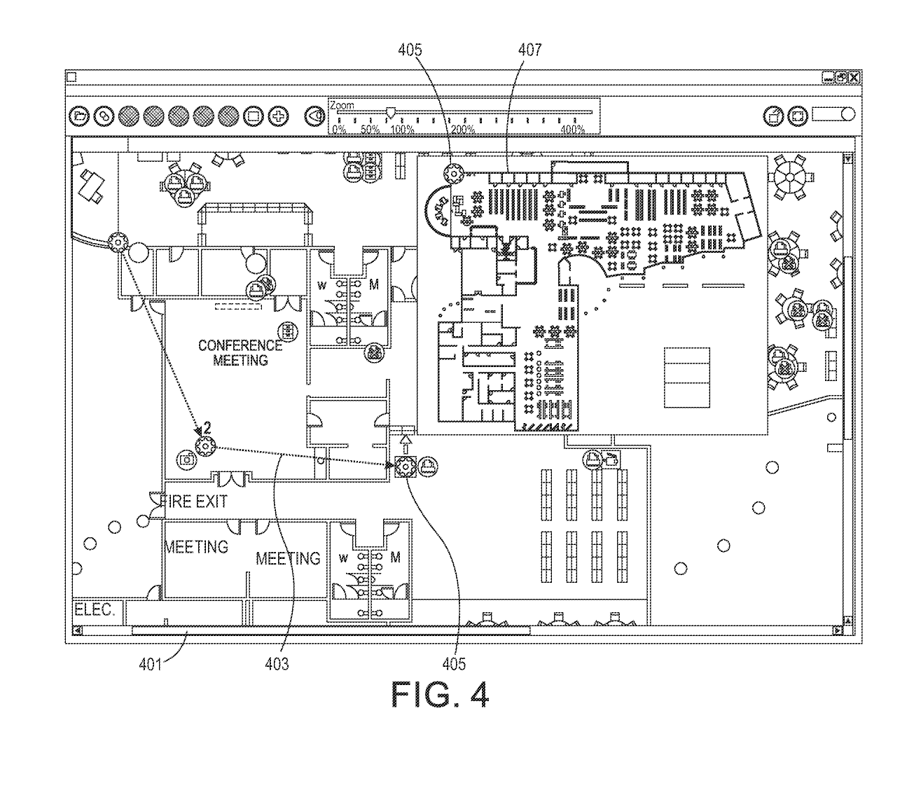

In addition, one or more of the process icons displayed in the workflow may be linking icons. A linking icon is an icon that illustrates a remote step in the workflow that occurs at least in part at a physical location that is not displayed in the current graphic representation of the facility. For example, the step may occur in a different room, or a different facility, that is away from the currently-displayed portion of the facility. When the system detects that a user has activated a linking icon, it may cause the display to output a representation of the location at which the remote step occurs. The representation may be in place of the currently-displayed location, or it may be a pop-up or additional representation that is displayed along with the current representation. FIG. 4 illustrates an example of a display of a first workplace environment area 401 at which various steps in a workflow 403 occur, a linking icon 405, and a second workplace environment 407 at which a step in the workflow that is associated with the linking icon occurs.

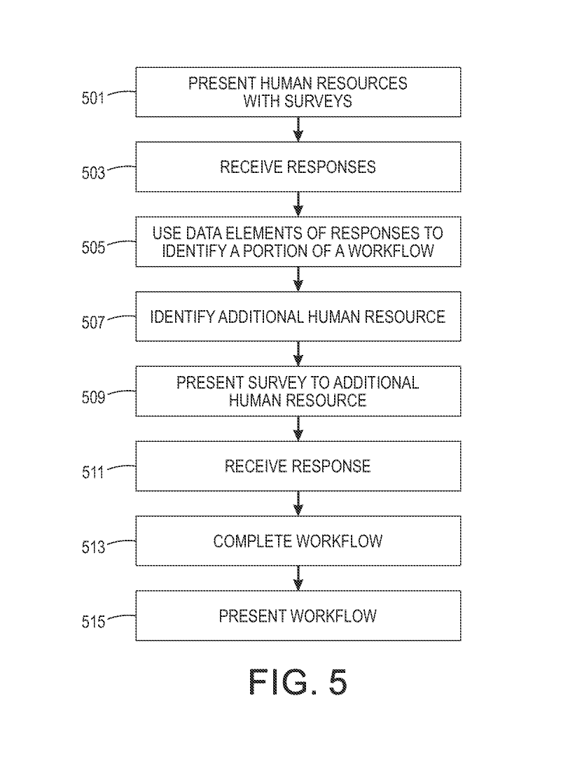

FIG. 5 illustrates a process by which the system may identify the workflow and develop the graphic representation. The system may identify the workflow and develop the graphic representation by presenting surveys (step 501) to various human resources that operate in the workplace. Each survey solicits, from the human resource, a data element set comprising at least the following data elements: a workplace, a parameter that describes an output, an input description, and an immediate next destination. The parameter that describes an output will be data that describes the output that the human resource is helping to produce. For example, the parameter may be a name, serial number or job number of the output, a name of an entity that ordered the output, a name of an entity that will receive the output, or other descriptive information about the output. The workplace resource will be one that the human resource uses to perform a task in a workflow that yields the output. An input description will be an identification of the resource or external source from which the human resource received the input for processing in the workflow. The immediate next destination will be the resource or external destination to which the human resource will send the result of its workflow tasks.

The survey may solicit other data, such as an identification of all other human resources who work with the surveyed human resource to perform a workflow task, a processing time, a description of inventory items that the human or non-human resource uses to perform a task, a processing time, or other data. Examples of such additional data may include, for example, information about the human resource's workload in a time period, metrics of the various jobs that the human resource processes (such as numbers of pages in a print job, numbers of other human resources that are connected to the job, or numbers of production resource stops in the job's workflow), purposes of various tasks that the human resource performs, suggestions for improving the workflow, and other data.

The survey also may solicit data about the entire process or any step of it, such as: (i) the number and type of steps in the process; (ii) the expected time or range of times that may be being spent on each step; (iii) the owner of each step (i.e., the human resource responsible for the step); (iv) a cost attributed to each step; (v) an expression of the value being added at each step in the process (e.g. Customer, Business, Non-Value Added); (vi) the resources being interacted with at the step (e.g. fax, printer, filing cabinet, etc.); and (vii) the system(s) in use during the step.

Optionally, at least some portions of the survey may be dynamic, meaning that after the user replies to a question, the system may use the reply to select a next question to present to the user in the survey. For example, if the user identifies a particular inventory item as being used in the workflow, the system may then ask the user whether the inventory item is in stock. If the item is in stock, the survey may proceed to ask additional questions about other parameters of the user's task. If the item is out of stock, the survey may ask questions about the cause, timing or alternative inventory items available that are associated with the out-of-stock event.

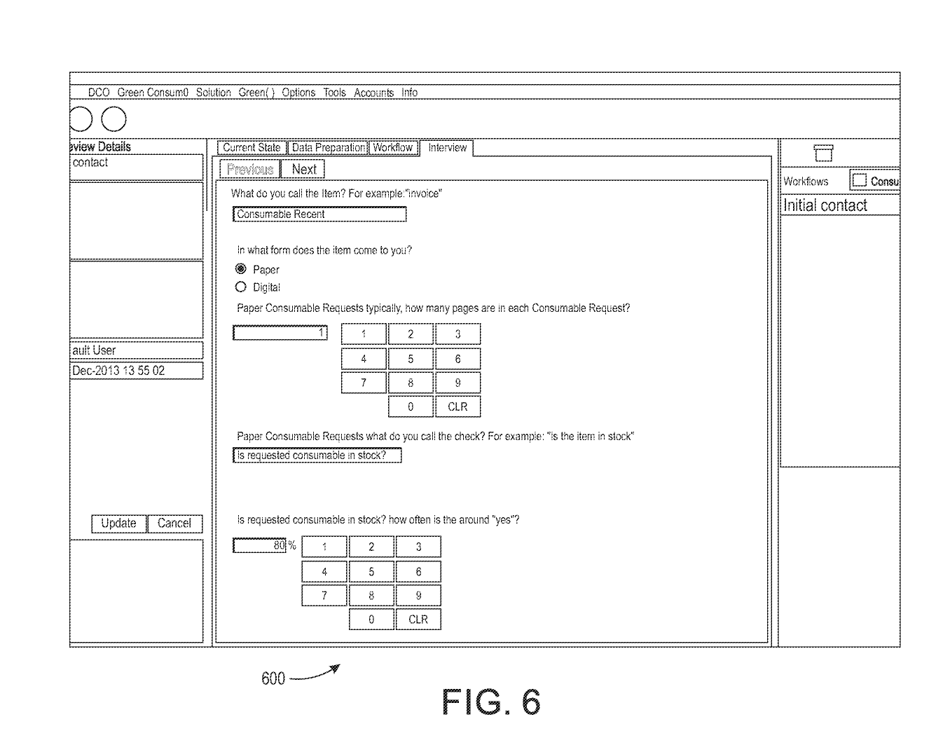

When soliciting the surveys from the human resources in the workplace environment, the system may do so by any suitable method. Examples include presenting the human resource with the survey via a workstation that the human resource uses in the workplace environment, presenting the survey via a mobile electronic device (such as a tablet computer or smartphone) that the user is using, or presenting the survey via a mobile electronic device that a human interviewer is using while talking with the human resource in the production environment. FIG. 6 illustrates an example of a user interface by which the system may present a survey 600 to a user.

Returning to FIG. 5, after the system solicits surveys from various human resources, it will receive responses from the human resources in response to the survey (step 503). Each response will include data elements that correspond to the solicited data element set. The system will then use the data elements received in the responses to automatically develop a portion of a workflow for a job that is produced in the workplace environment (step 505).

To develop a portion of a workflow for the job that is produced in the workplace environment, the system may analyze the data elements received in the survey response to select a subgroup of the responses that correspond to a single job. It may do this by, for example, comparing job identifiers in the response, entities or ordered the job, or entities who will receive the output from the job, to identify those responses for whom the data elements match. Once it selects a subgroup, it may then analyze a first response from the subgroup to identify the resource that is part of the response, analyze the first response's input description and immediate next destination to identify a second response that corresponds to an adjacent resource, and link the resource of the first response and the adjacent production resources as a segment of the workflow. It may continue to do this until all possible matches and/or segments are identified.

After developing a portion of the workflow, the system will use the developed portion of the workflow and the received data elements to identify an additional, not-yet-surveyed human resource to whom the survey should be presented (step 507). To do so, the system may identify a gap in the workflow. A gap will be a missing segment—i.e., an area that includes a starting node or ending node that corresponds to a particular human resource in the production environment, but which does not have at least two immediately adjacent nodes. The system will analyze the survey response for the particular human resource to identify the input description, immediate next destination or both that are contained in the survey response for the particular human resource. It will then select an unsurveyed human resource who is associated with the input description or immediate next destination that are contained in the survey response for the particular human resource.

The system will then present the survey to the additional (not-yet-surveyed) human resource (step 509), receive additional data elements for the data element set from the additional human resource (step 511), and use the received additional data elements to automatically complete the workflow for the job (step 513).

After the system completes the workflow, or at any point in the process (including when the workflow is only partially developed) the system may present the workflow (either in whole or to the extent identified) to a user (step 515). As an example of how the system may present the workflow, it may cause a display device that outputs a graphic representation of the workplace environment to output, with the graphic representation of the production environment, a graphic depiction of the workflow as a route that connects a of production resources in the production environment. Some or all of the connected production resources may be represented by a process icon that causes the display device to display the one or more parameters of a step of the workflow that occurs at the resource.

Optionally, when a user activates of one of the displayed process icons, the system may display additional process parameters associated with a workflow step that occurs at the icon's resource. Additionally or alternatively, when a user activates a displayed process icon, the system may automatically display a flowchart representation of a portion of the workflow that includes the resources that are associated with the activated process icon. If the process icon is a linking icon, when a user activates the icon the system may display an additional area of the workplace environment where a step that is associated with the icon occurs.

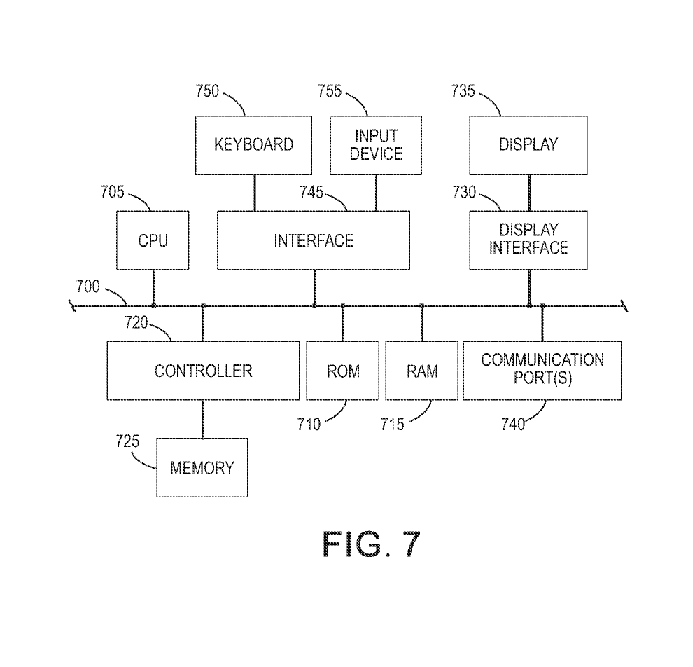

FIG. 7 depicts an example of internal hardware that may be used to contain or implement the various computer processes and systems as discussed above. An electrical bus 700 serves as an information highway interconnecting the other illustrated components of the hardware. CPU 705 is a central processing unit of the system, performing calculations and logic operations required to execute a program. CPU 705, alone or in conjunction with one or more of the other elements disclosed in FIG. 7, is a processing device, computing device or processor as such terms are used within this disclosure. When this disclosure or any claim uses the term “processor,” unless specifically stated otherwise it may include a single processor, or multiple processors that distributed within a system or among multiple systems in a way such that together they perform all steps of a defined method. Read only memory (ROM) 710 and random access memory (RAM) 715 constitute examples of memory devices. When this document or any claim uses the term “memory” or “computer-readable medium”, unless specifically stated otherwise it may include a single non-transitory device or more than one such device.

A controller 720 interfaces with one or more optional memory devices 725 that service as data storage facilities to the system bus 700. These memory devices 725 may include, for example, an external DVD drive or CD ROM drive, a hard drive, flash memory, a USB drive or another type of device that serves as a data storage facility. As indicated previously, these various drives and controllers are optional devices. Additionally, the memory devices 725 may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM 710 and/or the RAM 715. Optionally, the program instructions may be stored on a tangible computer readable medium such as a compact disk, a digital disk, flash memory, a memory card, a USB drive, an optical disc storage medium, a distributed computer storage platform such as a cloud-based architecture, and/or other recording medium.

A display interface 730 may permit information from the bus 700 to be displayed on the display 735 in audio, visual, graphic or alphanumeric format. Communication with external devices may occur using various communication ports 740. A communication port 740 may be attached to a communications network, such as the Internet, a local area network or a cellular telephone data network.

The hardware may also include an interface 745 which allows for receipt of data from input devices such as a keyboard 750 or other input device 755 such as a remote control, a pointing device, a video input device and/or an audio input device.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A workflow development system, comprising:
a display;
a processor; and
a non-transitory computer-readable media containing programming instructions that, when executed, instruct the processor to:
present, to a plurality of human resources in a workplace environment, a survey, wherein the survey solicits a data element set comprising at least the following data elements: a workplace resource, a parameter that describes an output, an input description, and an immediate next destination,
receive a plurality of responses from the human resources in response to the survey, wherein each response includes data elements that correspond to the solicited data element set,
use the data elements received in the responses to automatically develop a portion of a workflow for a job that is produced in the workplace environment, and
use the workflow and the received data elements to identify an additional human resource to whom the survey should be presented.

2. The system of claim 1, further comprising additional programming instructions that, when executed, instruct the processor to:
present the survey to the additional human resource;
receive additional data elements for the data element set from the additional human resource;
use the received additional data elements to automatically complete the workflow for the job; and
present the workflow as completed by the processor to a user.

3. The system of claim 2, wherein the instructions to present the workflow to the user comprise instructions to:
cause the display to output a graphic representation of the workplace environment along with a graphic depiction of the workflow as a route that connects a plurality of workplace resources in the workplace environment.

4. The system of claim 3, wherein the instructions to cause the display to output the graphic depiction of the workflow as a route that connects a plurality of workplace resources in the workplace environment comprise instructions to causing the display to output, for each connected workplace resource, a process icon that causes the display to output one or more parameters of a step of the workflow that occurs at the workplace resource.

5. The system of claim 4, further comprising additional programming instructions that, when executed, instruct the processor to:
receive a user input that comprises an activation of the displayed process icon; and
in response, cause the display to output a flowchart representation of a portion of the workflow that includes the workplace resource that is associated with the process icon.

6. The system of claim 4, wherein:
the process icon corresponds to a remote workplace resource that is present at a portion of the workplace environment that is not presently displayed on the display device; and
the system further comprises additional programming instructions that, when executed, instruct the processor to, when a user activates the process icon, cause the display to output the portion of the workplace environment at which the remote workplace resource is located.

7. The system of claim 1, wherein the instructions to automatically develop a portion of a workflow for a job that is produced in the workplace environment comprise instructions to:
analyze the received data elements received in the response to select a subgroup of the responses that correspond to a single job; and
for each first response in the subgroup:
analyze the first response to identify the workplace resource that is part of the first response,
analyze the first response's input description and immediate next destination to identify a second response that corresponds to an adjacent workplace resource, and
link the workplace resource of the first response and the adjacent workplace resources as a segment of the workflow.

8. The system of claim 1, wherein the instructions to use the workflow and the received data elements to identify an additional human resource to whom the survey should be presented comprise instructions to:
identify a gap in the workflow, wherein the gap includes a starting node or an ending node that corresponds to a particular human resource in the workplace environment;
analyze the survey response for the particular human resource to identify the input description, immediate next destination or both that are contained in the survey response for the particular human resource;
select an unsurveyed human resource who is associated with the input description or immediate next destination that are contained in the survey response for the particular human resource; and
identify the selected unsurveyed human resource as the additional human resource to whom the survey should be presented.

9. A workflow development system, comprising:
a display;
a processor; and
a non-transitory computer-readable media containing programming instructions that, when executed, instruct the processor to:
present, to a plurality of human resources in a workplace environment, a survey, wherein the survey solicits a data element set comprising at least the following data elements: a workplace resource, a parameter that describes an output, an input description, and an immediate next destination,
receive a plurality of responses from the human resources in response to the survey, wherein each response includes data elements that correspond to the solicited data element set,
use the data elements received in the responses to automatically develop a portion of a workflow for a job that is produced in the workplace environment,
use the workflow and the received data elements to identify an additional human resource to whom the survey should be presented,
present the survey to the additional human resource,
receive additional data elements for the data element set from the additional human resource,
use the received additional data elements to automatically complete the workflow for the job, and
cause the display to output a graphic representation of the workplace environment along with a graphic depiction of the workflow as a route that connects a plurality of workplace resources in the workplace environment.

10. The system of claim 9, wherein:
the instructions to cause the display to output the graphic depiction of the workflow as a route that connects a plurality of workplace resources in the workplace environment comprise instructions to causing the display to output, for each connected workplace resource, a process icon that causes the display to output one or more parameters of a step of the workflow that occurs at the workplace resource; and
the system further comprises additional programming instructions that, when executed, instruct the processor to:
receive a user input that comprises an activation of the displayed process icon, and
in response to the activation, cause the display to output a flowchart representation of a portion of the workflow that includes the workplace resource that is associated with the process icon.

11. The system of claim 9, wherein:
the instructions to cause the display to output the graphic depiction of the workflow as a route that connects a plurality of workplace resources in the workplace environment comprise instructions to causing the display to output, for each connected workplace resource, a process icon that causes the display to output one or more parameters of a step of the workflow that occurs at the workplace resource, wherein the process icon corresponds to a remote workplace resource that is present at a portion of the workplace environment that is not presently displayed on the display device; and
the system further comprises additional programming instructions that, when executed, instruct the processor to, when a user activates the process icon, cause the display to output the portion of the workplace environment at which the remote workplace resource is located.

12. The system of claim 9, wherein the instructions to automatically develop a portion of a workflow for a job that is produced in the workplace environment comprise instructions to:
analyze the received data elements received in the response to select a subgroup of the responses that correspond to a single job; and
for each first response in the subgroup:
analyze the first response to identify the workplace resource that is part of the first response,
analyze the first response's input description and immediate next destination to identify a second response that corresponds to an adjacent workplace resource, and
link the workplace resource of the first response and the adjacent workplace resources as a segment of the workflow.

13. The system of claim 9, wherein the instructions to use the workflow and the received data elements to identify an additional human resource to whom the survey should be presented comprise instructions to:
identify a gap in the workflow, wherein the gap includes a starting node or an ending node that corresponds to a particular human resource in the workplace environment;
analyze the survey response for the particular human resource to identify the input description, immediate next destination or both that are contained in the survey response for the particular human resource;
select an unsurveyed human resource who is associated with the input description or immediate next destination that are contained in the survey response for the particular human resource; and
identify the selected unsurveyed human resource as the additional human resource to whom the survey should be presented.

14. A method of gathering information for use in an automatic generation of a graphic representation of a workflow, the method comprising, by a processor:
presenting, to a plurality of human resources in a workplace environment, a survey, wherein the survey solicits a data element set comprising at least the following data elements: a workplace resource, a parameter that describes an output, an input description, and an immediate next destination;
receiving a plurality of responses from the human resources in response to the survey, wherein each response includes data elements that correspond to the solicited data element set;
using the data elements received in the responses to automatically develop a portion of a workflow for a job that is produced in the workplace environment; and
using the workflow and the received data elements to identify an additional human resource to whom the survey should be presented.

15. The method of claim 14, further comprising:
presenting the survey to the additional human resource;
receiving additional data elements for the data element set from the additional human resource;
using the received additional data elements to automatically complete the workflow for the job; and
presenting the workflow as completed by the processor to a user.

16. The method of claim 15, wherein presenting the workflow to the user comprises:
causing a display device that outputs a graphic representation of the workplace environment to output, with the graphic representation of the workplace environment, a graphic depiction of the workflow as a route that connects a plurality of workplace resources in the workplace environment.

17. The method of claim 16, wherein causing the display device to output the graphic depiction of the workflow as a route that connects a plurality of workplace resources in the workplace environment comprises causing the display device to output, for each connected workplace resource, a process icon that causes the display device to display one or more parameters of a step of the workflow that occurs at the workplace resource.

18. The method of claim 17, further comprising:
receiving a user input that comprises an activation of the displayed process icon; and
in response, automatically displaying a flowchart representation of a portion of the workflow that includes the workplace resource that is associated with the process icon.

19. The method of claim 17, wherein the process icon corresponds to a remote workplace resource that is present at a portion of the workplace environment that is not presently displayed on the display device, and when a user activates the process icon, the system causes the display device to display the portion of the workplace environment at which the remote workplace resource is located.

20. The method of claim 14, wherein automatically developing a portion of a workflow for a job that is produced in the workplace environment comprises:
analyzing the received data elements received in the response to select a subgroup of the responses that correspond to a single job; and
for each first response in the subgroup:
analyzing the first response to identify the workplace resource that is part of the first response,
analyzing the first response's input description and immediate next destination to identify a second response that corresponds to an adjacent workplace resource, and
linking the workplace resource of the first response and the adjacent workplace resources as a segment of the workflow.

21. The method of claim 20, wherein using the workflow and the received data elements to identify an additional human resource to whom the survey should be presented comprises:
identifying a gap in the workflow, wherein the gap includes a starting node or an ending node that corresponds to a particular human resource in the workplace environment;
analyzing the survey response for the particular human resource to identify the input description, immediate next destination or both that are contained in the survey response for the particular human resource;
selecting an unsurveyed human resource who is associated with the input description or immediate next destination that are contained in the survey response for the particular human resource; and
identifying the selected unsurveyed human resource as the additional human resource to whom the survey should be presented.
